(19) United States
(12) Patent Application Publication
(10) Pub. No.: US 2024/0236076 A1
(43) Pub. Date: Jul. 11, 2024

(54) Authenticating Data And Communication Sources

(71) Applicant: Avea Media Inc, Brampton (CA)

(72) Inventor: Michael Berkeley Paul, Brampton (CA)

(21) Appl. No.: 18/563,195

(22) PCT Filed: May 27, 2022
(86) PCT No.: PCT/IB2022/000328

§ 371 Date: Nov. 21, 2023

Related U.S. Application Data
(60) Provisional application No. 63/193,646, filed on May 27, 2021.

(51) Int. Cl. H04L 9/40

(52) U.S. Cl. CPC H04L 63/0823

(57) ABSTRACT

Aspects of the disclosure provide for methods, systems, and apparatus, including computer-readable storage media for verifying the sources of incoming messages and requests for communication to a computing device. A system can receive a verification request to verify the source of a communication between a source computing device and a recipient computing device. The system can determine, from data defining a mapping between one or more first source identifiers and a user, whether the mapping includes a first source identifier and a second source identifier of the communication request. The mapping can be generated using a digital certificate associated with the user. The one or more first source identifiers can be mapped to the user after the digital certificate is created. The system can send a response to the verification request to the recipient computing device, the response identifying the source of the communication as the user.

### CROSS-REFERENCE TO RELATED APPLICATION

This application claims the benefit of the filing date of U.S. Provisional Patent Application No. 63/193,646, filed on May 27, 2021, the disclosure of which is hereby incorporated by reference herein in its entirety.

### BACKGROUND

Computing devices, such as smartphones, can send and receive calls or text messages through communication with multiple devices over a network. Some entities, such as phone companies, manage communication between these devices, including managing caller IDs that ostensibly identify the source of an incoming call or text message. Phone companies often rely on information provided by the owner of the phone number to corroborate the number with an identity. As a result, malicious actors may, in some cases, succeed in registering caller IDs that are similar or attempt to mimic the caller ID of a legitimate business. Recipients of phone calls from these actors can mistakenly believe they are from legitimate businesses, and as a result, this may lead to some recipients providing sensitive information to such actors because of their misguided reliance on the incorrect identity provided through the caller ID.

One reason that businesses are discouraged from verifying sources of communications is the time and resources required to do so. A consequence of this is that malicious actors can take advantage of the difficult and time-consuming nature of caller verification. For example, this is evidenced by the proliferation of software for automatic mass dialing or texting. Further, relying on phone companies and other service providers to separately verify the users of their respective networks or services to communicate is a chain as strong as its weakest link—as malicious actors can target for abuse services in which verification of the source of calls or texts made across the service is lax or non-existent.

### BRIEF SUMMARY

Aspects of the disclosure are directed to methods, systems, and apparatuses, including computer-readable storage media, for verifying incoming communication requests, such as phone calls or text messages, as originating from a device corresponding to a particular entity. A system as described herein can register, as a user of the system, an entity from its digital certificate for a domain verified to be controlled by the entity. A system as described herein can register the entity and map the entity to one or more source identifiers, such as phone numbers, as valid sources of communication received from the entity. The system as described herein can verify whether incoming communications belong to the entity or, conversely, can recognize communications originating from malicious actors posing as a legitimate business or individual. This is possible even when the communications are not communications that require the use of a digital certificate to perform.

A first aspect of the disclosure is directed to a system including, in a first example: one or more processors coupled to memory, the one or more processors configured to: receive a verification request to verify the source of a communication between a source computing device and a recipient computing device, the verification request including a second source identifier; determine, through accessing of a database, whether the database includes a first source identifier from among one or more user source identifiers stored in the database, the first source identifier matching the second source identifier; and when the database includes the first source identifier: identify the user mapped to the first source identifier, wherein the first source identifier and the user are mapped using a digital certificate associated by the system with the user; and send a response to the verification request to the recipient computing device, the response identifying the source of the communication as the user.

In a second example of the first aspect, the system of the first example may include identifiers such that the first source identifier includes a first name mapped to the user and the second source identifier includes a second name. Further, in determining whether the database comprises a first source identifier matching the second source identifier, the one or more processors may be further configured to determine whether the second name of the second source identifier matches the first name mapped to the user.

In a third example of the first aspect, the system of the first or second example may include a second source identifier that is a phone number. And, to determine whether the database comprises a first source identifier matching the second source identifier, the one or more processors may be further configured to determine whether the one or more user source identifiers comprise a phone number matching the phone number of the second source identifier. In a fourth example of the first aspect, the system of any one of the first through third examples may include one or more processors that are further configured to maintain, in the memory, the database. In a fifth example of the first aspect, the database of the fourth example of the system may include, for each user of a plurality of users, one or more respective source identifiers mapped to the user.

In a sixth example of the first aspect, the system of any one of the first through fifth examples may include a digital certificate that is further associated with a domain of one or more computing devices and the one or more processors are further configured to generate a mapping between the first source identifier and the user. To generate the mapping, the one or more processors may be configured to: receive a registration request to register the user, the registration request comprising the digital certificate and data identifying the domain; and authenticate the user using the digital certificate and the domain. In a seventh example of the first aspect, the system of the sixth example may include one or more processors that are further configured to send, in response to the registration request, a challenge string. Further, the one or more processors may also be configured to determine that one or more domain name system (DNS) records of the domain have been updated with the challenge string. In an eighth example of the first aspect, the system of the sixth or seventh example may include one or more processors that are further configured to receive a request to update the mapping to include one or more additional source identifiers, the request being associated with the user. The one or more processors may also be configured to determine that the request to update the mapping was received from a computing device corresponding to the user, and in response, update the mapping to include the one or more additional source identifiers. In a ninth example of the first aspect, the eighth example may also involve determining that the request to update the mapping was received from a computing device corresponding to the user based on the one or more processors being configured to determine whether the computing device corresponds to a user account for the user. In a tenth example of the first aspect, the system of any one of the sixth through ninth examples may have a domain that is a first domain and the one or more first source identifiers that are mapped to the user include an email address corresponding to a second domain different from the first domain.

In an eleventh example of the first aspect, the system of any one of the first and fourth through tenth examples may have a second source identifier that includes at least a phone number, an email address, a user account of an online platform or an internal network identifier for a device in a network of plurality of devices. In a twelfth example of the first aspect, the system of any one of the first through eleventh examples may include a digital certificate that is an Extended Validation (EV) digital certificate. In a thirteenth example of the first aspect, the digital certificate of the twelfth example may be an Extended Validation Transport Layer Security (EV TLS) digital certificate. In a fourteenth example of the first aspect, any one of the first through thirteenth examples may have a digital certificate that includes one or more third source identifiers such that the first source identifier is different from the one or more third source identifiers.

A second aspect of the disclosure is directed to a method, wherein, in a first example, the method includes receiving, by one or more processors, a verification request to verify the source of a communication between a source computing device and a recipient computing device, the verification request including a second source identifier; determining, by the one or more processors and through accessing of a database, whether the database includes a first source identifier from among one or more user source identifiers stored in the database, the first source identifier matching the second source identifier; and when the database includes the first source identifier: identifying, by the one or more processors, the user mapped to the first source identifier, wherein the first source identifier and the user are mapped using a digital certificate associated by the system with the user; and sending, by the one or more processors, a response to the verification request to the recipient computing device, the response identifying the source of the communication as the user.

In a second example of the second aspect, the method of the first example may include identifiers such that the first source identifier includes a first name mapped to the user and the second source identifier includes a second name. Further, in determining whether the database comprises a first source identifier matching the second source identifier, the method may involve determining whether the second name of the second source identifier matches the first name mapped to the user.

In a third example of the second aspect, the method of the first or second example may include determining whether the database comprises a first source identifier matching a second source identifier that is a phone number. And, the method may also involve determining whether the one or more user source identifiers comprise a phone number matching the phone number of the second source identifier. In a fourth example of the second aspect, the method of any one of the first through third examples may involve maintaining the database in the memory via the one or more processors. In a fifth example of the second aspect, the database of the fourth example of the method may include, for each user of a plurality of users, one or more respective source identifiers mapped to the user.

In a sixth example of the second aspect, the method of any one of the first through fifth examples may include a digital certificate that is further associated with a domain of one or more computing devices and the method may also include generating, by the one or more processors, a mapping between the first source identifier and the user. The mapping may be generated by: receiving a registration request to register the user, the registration request comprising the digital certificate and data identifying the domain; and authenticating the user using the digital certificate and the domain. In a seventh example of the second aspect, the method of the sixth example may include sending, by the one or more processors and in response to the registration request, a challenge string. Further, the method may also include determining that one or more domain name system (DNS) records of the domain have been updated with the challenge string. In an eighth example of the second aspect, the method of the sixth or seventh example may include receiving, by the one or more processors, a request to update the mapping to include one or more additional source identifiers, the request being associated with the user. The method may also include determining, by the one or more processors, that the request to update the mapping was received from a computing device corresponding to the user, and in response, updating, by the one or more processors, the mapping to include the one or more additional source identifiers. In a ninth example of the second aspect, the eighth example may also involve determining that the request to update the mapping was received from a computing device corresponding to the user based on determining whether the computing device corresponds to a user account for the user. In a tenth example of the second aspect, the method of any one of the sixth through ninth examples may have a domain that is a first domain and the one or more first source identifiers that are mapped to the user include an email address corresponding to a second domain different from the first domain.

In an eleventh example of the second aspect, the method of any one of the first and fourth through tenth examples may have a second source identifier that includes at least a phone number, an email address, a user account of an online platform or an internal network identifier for a device in a network of plurality of devices. In a twelfth example of the second aspect, the method of any one of the first through eleventh examples may include a digital certificate that is an Extended Validation (EV) digital certificate. In a thirteenth example of the second aspect, the digital certificate of the twelfth example may be an Extended Validation Transport Layer Security (EV TLS) digital certificate. In a fourteenth example of the second aspect, any one of the first through thirteenth examples may have a digital certificate that includes one or more third source identifiers such that the first source identifier is different from the one or more third source identifiers.

A third aspect of the disclosure is directed to one or more computer-readable storage media storing instructions that when executed by one or more processors, causes the one or more processors to perform operations including, in a first example: receiving a verification request to verify the source of a communication between a source computing device and a recipient computing device, the verification request including a second source identifier; determining, through accessing of a database, whether the database includes a first source identifier from among one or more user source identifiers stored in the database, the first source identifier matching the second source identifier; and when the database includes the first source identifier: identifying the user mapped to the first source identifier, wherein the first source identifier and the user are mapped using a digital certificate associated by the system with the user; and sending a response to the verification request to the recipient computing device, the response identifying the source of the communication as the user.

In a second example of the third aspect, the computer-readable storage media of the first example may include identifiers such that the first source identifier includes a first name mapped to the user and the second source identifier includes a second name. Further, in determining whether the database comprises a first source identifier matching the second source identifier, the computer-readable storage media may involve determining whether the second name of the second source identifier matches the first name mapped to the user.

In a third example of the third aspect, the computer-readable storage media of the first or second example may include operations that involve determining whether the database comprises a first source identifier matching a second source identifier that is a phone number. And, the computer-readable storage media may also include operations involving determining whether the one or more user source identifiers comprise a phone number matching the phone number of the second source identifier. In a fourth example of the third aspect, the computer-readable storage media of any one of the first through third examples may involve operations that include maintaining the database in the memory. In a fifth example of the third aspect, the database of the fourth example of the computer-readable storage media may include, for each user of a plurality of users, one or more respective source identifiers mapped to the user.

In a sixth example of the third aspect, the computer-readable storage media of any one of the first through fifth examples may process a digital certificate that is further associated with a domain of one or more computing devices and the computer-readable storage media may also include operations that involve generating a mapping between the first source identifier and the user. The mapping may be generated by: receiving a registration request to register the user, the registration request comprising the digital certificate and data identifying the domain; and authenticating the user using the digital certificate and the domain. In a seventh example of the third aspect, the computer-readable storage media of the sixth example may involve operations including sending, in response to the registration request, a challenge string. Further, the computer-readable storage media may also include an operation of determining that one or more domain name system (DNS) records of the domain have been updated with the challenge string. In an eighth example of the third aspect, the computer-readable storage media of the sixth or seventh example may involve operations that include receiving a request to update the mapping to include one or more additional source identifiers, the request being associated with the user. The computer-readable storage media may also involve operations including determining that the request to update the mapping was received from a computing device corresponding to the user, and in response, updating the mapping to include the one or more additional source identifiers. In a ninth example of the third aspect, the eighth example may also involve operations including determining that the request to update the mapping was received from a computing device corresponding to the user based on determining whether the computing device corresponds to a user account for the user. In a tenth example of the third aspect, the computer-readable storage media of any one of the sixth through ninth examples may perform operations based on a domain that is a first domain where one or more first source identifiers that are mapped to the user include an email address corresponding to a second domain different from the first domain.

In an eleventh example of the third aspect, the computer-readable storage media of any one of the first and fourth through tenth examples may process a second source identifier that includes at least a phone number, an email address, a user account of an online platform or an internal network identifier for a device in a network of plurality of devices. In a twelfth example of the third aspect, the computer-readable storage media of any one of the first through eleventh examples may process a digital certificate that is an Extended Validation (EV) digital certificate. In a thirteenth example of the third aspect, the digital certificate of the twelfth example may be an Extended Validation Transport Layer Security (EV TLS) digital certificate. In a fourteenth example of the third aspect, the computer-readable storage media of any one of the first through thirteenth examples may process a digital certificate that includes one or more third source identifiers such that the first source identifier is different from the one or more third source identifiers.

A fourth aspect of the disclosure is directed to a system including one or more processors configured to, in a first example: maintain, in memory coupled to the one or more processors, a database including one or more user source identifiers stored in the database, each of the one or more user source identifiers being mapped to a registered user from among one or more registered users of the system; receive a verification request to verify the source of a communication between a source computing device and a user computing device, the verification request including a second source identifier; determine whether the database includes a first source identifier among the one or more user source identifiers that matches the second source identifier, and when the database includes the first source identifier: identify the user mapped to the first source identifier, wherein the first source identifier and the user are mapped using a digital certificate associated by the system with the user; and send a response to the verification request identifying the source of the communication as the user.

In a second example of the fourth aspect, the system of the first example may also include a user computing device that is configured to: send the verification request; receive the response, and interact with a server as a client, wherein the server comprises the one or more processors.

A fifth aspect of the disclosure is directed to a method of registering user information with a verification database including, in a first example: receiving, by one or more processors, a registration request from a user to register the user, the registration request having first information including a digital certificate and a domain, and one or more source identifiers identifying sources of communication from the user to one or more computing devices; sending, by the one or more processors and in response to the registration request, a challenge string; determining, by the one or more processors, whether one or more domain name system (DNS) records of the domain have been updated with the challenge string; and when the one or more domain name system (DNS) records of the domain have been updated with the challenge string, registering the user as associated with the first information, and mapping the one or more source identifiers to the user.

In a second example of the fifth aspect, the method of the first example may also include: receiving, by the one or more processors, a second request to update the first information of the user, the second request including one or more additional source identifiers for mapping to the user, wherein the one or more additional source identifiers are mapped to the user if the request is received from a computing device corresponding to the user. In a third example of the fifth aspect, the method of the first or second example may also include: determining, by the one or more processors, that the request to update the mapping was received from a computing device corresponding to the user, further comprising determining whether the computing device corresponds to a user account for the user.

A sixth aspect of the disclosure is directed to a system of one or more processors coupled to memory, the one or more processors configured to, in a first example: receive a registration request from a user to register the user, the registration request having first information including a digital certificate and a domain, and one or more source identifiers identifying sources of communication from the user to one or more computing devices; send, in response to the registration request, a challenge string; determine, by the one or more processors, whether one or more domain name system (DNS) records of the domain have been updated with the challenge string; and when the one or more domain name system (DNS) records of the domain have been updated with the challenge string: register the user as associated with the first information, and map the one or more source identifiers to the user.

In a second example of the sixth aspect, the system of the first example may be further configured such that the one or more processors are configured to receive a second request to update the first information of the user, the second request including one or more additional source identifiers for mapping to the user, wherein the one or more additional source identifiers are mapped to the user if the request is received from a computing device corresponding to the user. In a third example of the sixth aspect, the system of the first or second example may be further configured such that the one or more processors are configured to determine that the request to update the mapping was received from a computing device corresponding to the user, wherein to determine that the request to update was received from the computing device, the one or more processors are further configured to determine whether the computing device corresponds to a user account for the user.

A seventh aspect of the disclosure is directed to one or more computer-readable storage media storing instructions that when executed by one or more processors, causes the one or more processors to perform operations including, in a first example: receiving a registration request from a user to register the user, the registration request having first information including a digital certificate and a domain, and one or more source identifiers identifying sources of communication from the user to one or more computing devices; sending in response to the registration request, a challenge string; determining whether one or more domain name system (DNS) records of the domain have been updated with the challenge string; and when the one or more domain name system (DNS) records of the domain have been updated with the challenge string, registering the user as associated with the first information, and mapping the one or more source identifiers to the user.

In a second example of the seventh aspect, the operations of the computer-readable storage media of the first example may include receiving a second request to update the first information of the user, the second request including one or more additional source identifiers for mapping to the user, wherein the one or more additional source identifiers are mapped to the user if the request is received from a computing device corresponding to the user. In a third example of the seventh aspect, the operations of the computer-readable storage media of the first or second example may include determining that the request to update the mapping was received from a computing device corresponding to the user, further comprising determining whether the computing device corresponds to a user account for the user.

The foregoing and other aspects of the disclosure can include one or more of the following features, alone or in combination. For example, one implementation can include all of the features in combination.

A system can further include a user computing device configured to: send the verification request, receive the response, and interact with a server as a client, wherein the server includes the one or more processors.

The first source identifier is a first name mapped to the user; the second source identifier is a second name; and determining whether the database includes a first source identifier matching the second source identifier, the one or more processors are further configured to determine whether the second name of the second source identifier matches the first name mapped to the user.

The second source identifier is a phone number; and determining whether the database includes a first source identifier matching the second source identifier includes determining whether the one or more user source identifiers includes a phone number matching the phone number of the second source identifier.

The one or more processors can be further configured to maintain, in the memory, the database.

The database can include, for each user of a plurality of users, one or more respective source identifiers mapped to the user.

The database can include one or more data structures. The database can be configured to manage the one or more data structures, including performing one or more of receiving a query to access data stored in the one or more data structures, generating a response to the query with queried data, and updating data stored in the one or more data structures. The one or more data structures can include a blockchain. When the database includes one or more blockchains, the one or more blockchains can be stored in persistent memory. When the database includes one or more blockchains, the one or more blockchains can be stored in temporary memory.

The digital certificate is further associated with a domain of one or more computing devices, and the one or more processors are further configured to generate a mapping between the first source identifier and the user, wherein to generate the mapping, the one or more processors are configured to: receive a registration request to register the user, the registration request including the digital certificate and data identifying the domain; and authenticate the user using the digital certificate and the domain.

The one or more processors are further configured to: send, in response to the registration request, a challenge string; and determine that one or more domain name system (DNS) records of the domain have been updated with the challenge string.

The one or more processors are further configured to: receive a request to update the mapping to include one or more additional source identifiers, the request being associated with the user; and determine that the request to update the mapping was received from a computing device corresponding to the user, and in response, update the mapping to include the one or more additional source identifiers.

To determine that the request to update the mapping was received from a computing device corresponding to the user, the one or more processors are configured to determine whether the computing device corresponds to a user account for the user.

The domain is a first domain, and wherein the one or more first source identifiers mapped to the user includes an email address corresponding to a second domain different from the first domain.

The second source identifier includes at least one or more of: a phone number, an email address, a user account of an online platform, or an internal network identifier for a device in a network of plurality of devices.

The digital certificate is an Extended Validation (EV) digital certificate.

The digital certificate is an Extended Validation Transport Layer Security (EV TLS) digital certificate.

The digital certificate includes one or more third source identifiers, and wherein the first source identifier is different from the one or more third source identifiers.

The digital certificate includes one or more third source identifiers and the first source identifier is not found in the digital certificate. The digital certificate does not include the first source identifier.

The one or more processors are further configured to receive a second request to update the first information of the user, the second request including one or more additional source identifiers for mapping to the user, wherein the one or more additional source identifiers are mapped to the user if the request is received from a computing device corresponding to the user.

The one or more processors are further configured to determine that the request to update the mapping was received from a computing device corresponding to the user, wherein to determine that the request to update was received from the computing device, the one or more processors are further configured to determine whether the computing device corresponds to a user account for the user.

Other aspects of the disclosure include instructions stored on computer-readable storage media that, when implemented, cause one or more processors to perform actions of one or more methods.

In an eighth aspect, the present disclosure relates to a method of making a source-verified non-fungible token using a verification system. In one example, the method includes: receiving, by one or more processors, a request to create a source-verified non-fungible token, the request including first information and second information, the first information including a digital certificate and a domain, and the second information including a media file; sending, by the one or more processors and in response to the request, a challenge string; determining, by the one or more processors, whether one or more domain name system (DNS) records of the domain have been updated with the challenge string; and when the one or more domain name system (DNS) records of the domain have been updated with the challenge string, creating the source-verified non-fungible token including the media file and meta data indicating that the domain is the creator of the media file.

In a second example of the eighth aspect, the receiving step in the first example may include receiving the request from a user. In a third example of the eighth aspect, the first or second example may include creating the source-verified non-fungible token by using the verification system to generate a private key and a public key, wherein the private key encrypts the contents of the source-verified non-fungible token. In a fourth example, any one of the first through third examples may include creating the source-verified non-fungible token with asymmetric encryption. In a fifth example of the eighth aspect, the non-fungible token of any one of the first through fourth examples may be placed onto a blockchain. In a sixth example of the eighth aspect, any one of the first through fifth examples may include creating the source-verified non-fungible token by incorporating meta data that authenticates the domain, the authentication being visually watermarked as plain text or a barcode. In a seventh example of the eighth aspect, the media file in any one of the first through sixth examples may be one of a video or an image.

In a ninth aspect, the present disclosure relates to one or more computer-readable storage media storing instructions that when executed by one or more processors, causes the one or more processors to perform operations that result in the creation of a non-fungible token. In one example, the one or more computer-readable storage media storing instructions that when executed by one or more processors, causes the one or more processors to perform operations includes: receiving a request to create a source-verified non-fungible token, the request including first information and second information, the first information including a digital certificate and a domain, and the second information including a media file; sending, in response to the request, a challenge string; determining whether one or more domain name system (DNS) records of the domain have been updated with the challenge string; and when the one or more domain name system (DNS) records of the domain have been updated with the challenge string, creating the source-verified non-fungible token including the media file and meta data indicating that the domain is the creator of the media file.

In a second example of the ninth aspect, the receiving step in the first example may include receiving the request from a user. In a third example of the ninth aspect, the first or second example may include creating the source-verified non-fungible token by using the verification system to generate a private key and a public key, wherein the private key encrypts the contents of the source-verified non-fungible token. In a fourth example, any one of the first through third examples may include creating the source-verified non-fungible token with asymmetric encryption. In a fifth example of the ninth aspect, the non-fungible token of any one of the first through fourth examples may be placed onto a blockchain. In a sixth example of the ninth aspect, any one of the first through fifth examples may include creating the source-verified non-fungible token by incorporating meta data that authenticates the domain, the authentication being visually watermarked as plain text or a barcode. In a seventh example of the ninth aspect, the media file in any one of the first through sixth examples may be one of a video or an image.

In a tenth aspect, the present disclosure relates to a verification system for the creation of a source-verified non-fungible token. In one example of the tenth aspect, the verification system includes: one or more processors coupled to memory, the one or more processors configured to: receive a request to create a source-verified non-fungible token, the request including first information and second information, the first information including a digital certificate and a domain, and the second information including a media file; send, in response to the request, a challenge string; determine whether one or more domain name system (DNS) records of the domain have been updated with the challenge string; and when the one or more domain name system (DNS) records of the domain have been updated with the challenge string, create the source-verified non-fungible token including the media file and meta data indicating that the domain is the creator of the media file.

In a second example of the tenth aspect, the first example may include that the one or more processors are configured to receive the request from a user. In a third example of the tenth aspect, the one or more processors of the first or second example may be configured to create the source-verified non-fungible token by using the verification system to generate a private key and a public key, wherein the private key encrypts the contents of the source-verified non-fungible token. In a fourth example, the one or more processors of any one of the first through third examples may be configured to create the source-verified non-fungible token with asymmetric encryption. In a fifth example of the tenth aspect, the one or more processors of any one of the first through fourth examples may be configured to place the non-fungible token onto a blockchain. In a sixth example of the tenth aspect, the one or more processors of any one of the first through fifth examples may be configured to create the source-verified non-fungible token by incorporating meta data that authenticates the domain, the authentication being visually watermarked as plain text or a barcode. In a seventh example of the tenth aspect, the media file received in any one of the first through sixth examples may be one of a video or an image.

### BRIEF DESCRIPTION OF THE DRAWINGS

FIG. 1 is a block diagram of the example verification system, according to aspects of the disclosure.

FIG. 2 is a block diagram of an example computing environment in which an example verification system is implemented, according to aspects of the disclosure.

FIG. 3 is a diagram showing an example process for verifying the source of an incoming communication, according to aspects of the disclosure.

FIG. 4 is a diagram showing an example process for verifying the source of an incoming communication request when the verification system is implemented on a server computing device, according to aspects of the disclosure.

FIG. 5 is a diagram showing another example process for verifying the incoming communication request when the verification system is implemented on a user computing device, according to aspects of the disclosure.

FIG. 6 is a flowchart of an example process for authenticating a user sending an incoming registration request to the verification system, according to aspects of the disclosure.

FIG. 7 is a diagram of an example process for registering an entity with a verification system, according to aspects of the disclosure.

### DETAILED DESCRIPTION

Aspects of the disclosure are directed to methods, systems, and apparatuses, including computer-readable storage media, for verifying incoming communication requests, such as phone calls or messages, as originating from a particular entity registered with a verification system. A computing device can receive a communication request, for example as an incoming phone call or text message. The computing device can view a caller ID and a phone number, for example, which can appear to be coming from a particular business or organization. Often, malicious actors will pose as legitimate businesses, and use caller IDs that are similar to those registered by a phone company that facilitates the transmission of the call or message.

On the other hand, sources of web traffic, such as data communicated to and from a web browser and a host server, can be authenticated by a digital certificate associated with the host server.

A digital certificate can be data used as part of authenticating an entity named in the digital certificate. The digital certificate can be issued by a certificate authority or other trusted party, and different types of certificates exist, such as Transport Layer Security (TLS) certificates, Security Sockets Layer (SSL) certificates, and Extended Verification (EV) digital certificates, including EV SSL or TLS certificates. Although TLS and SSL are provided as examples, in general the digital certificate may be implemented using any cryptographic protocol for communicating data over devices in a network. A digital certificate can identify one or more network addresses, such as Internet Protocol (IP) addresses for servers hosted or controlled by a party indicated in the digital certificate. IP addresses for the servers are mapped to domain names, which are managed by a domain name system (DNS). Digital certificates can specify a range of network addresses for different devices under a common domain or subdomain. A digital certificate can include some information related to the entity, such as the entity's name or a point of contact, and can also include a public cryptographic key used by other entities to communicate with devices in the domain controlled by the entity named in the digital certificate.

Some digital certificates, such as EV digital certificates, are issued by certificate authorities after investigation into an entity requesting a certificate. The certificate can specify a domain of computing devices, and third parties external to the domain can communicate with the domain with the assurance of its legitimacy based on the digital certificate.

Aspects of the disclosure are directed to a system that leverages digital certificates commonly reserved for web traffic to other forms of incoming communication received by a computing device. For example, a verification system as provided herein can verify incoming calls or messages from phone numbers, email addresses, computing platform accounts, and other source identifiers as belonging to a user registered with the verification system. The registered user can be an entity with a digital certificate, the registered user using its digital certificate as part of a registration process for mapping one or more source identifiers to the user. Thereafter, when a computing device in communication with the verification system receives a communication request, such as an incoming call, the verification system can compare the phone number of the incoming call against source identifiers associated with registered users in a database maintained by the system. The verification system can determine whether the user is mapped to a source identifier that matches the source identifier of the communication request, e.g., phone number, and respond to a verification request sent to the system with the name of the mapped user. A computing device can expeditiously receive verification as to whether the incoming call is genuinely from a source associated with an entity, or if the call is from an unknown source, such as a malicious actor pretending to be the entity in question.

The system as described herein can extend the functionality of digital certificates commonly used to authenticate web traffic to other sources of communication. The system can track many different source identifiers, identifying sources of communication that have been registered by a user of the verification system as belonging to that user. The system can quickly update source identifiers without requiring the digital certificate, as the digital certificate is only required during an initial registration of the user with the system. The system can maintain mappings between source identifiers and users independent of any identifying information in a corresponding digital certificate. In this way, the verification system provides for extending the functionality of digital certificates in identifying the sources of incoming phone calls, text messages, or messages on social media platforms, among other similar sources, whereas conventionally a digital certificate provides a narrow scope of information about an entity. Moreover, what information is available on a digital certificate can require a certificate authority to issue a new digital certificate altogether to update the information.

The system as described herein can provide verification between computing devices in a network, without requiring that the computing devices receive a private key that matches a public key in a digital certificate. In other words, one device can verify its identity as associated with a user of the system, without the device having access to sensitive information that would otherwise be required if verification were done through the use of the digital certificate.

The system as described herein can be implemented across a variety of different types of devices and forms of communication. For example, a system as described herein can be implemented on a mobile smart phone and be configured to automatically screen incoming messages, which can include direct messages, calls, or other forms of communication sent through social media platforms, as examples. In this way, aspects of the disclosure provide for a layer of verification of incoming communications independent of systems or platforms facilitating those communications, such as telephone companies or social media platforms. Aspects of the disclosure as described herein can also be advantageous in reducing the chance of incorrectly screening communication requests from legitimate sources or incorrectly allowing communication requests from malicious actors. This is at least because the system positively matches source identifiers to different users. Whereas past approaches rely on learned characteristics of fraudulent messages to determine whether or not to block an incoming call or communication, the system as described herein performs a one-time registration process to identify a user, and can deterministically reference source identifiers mapped to the user registered with the system.

### Example Systems

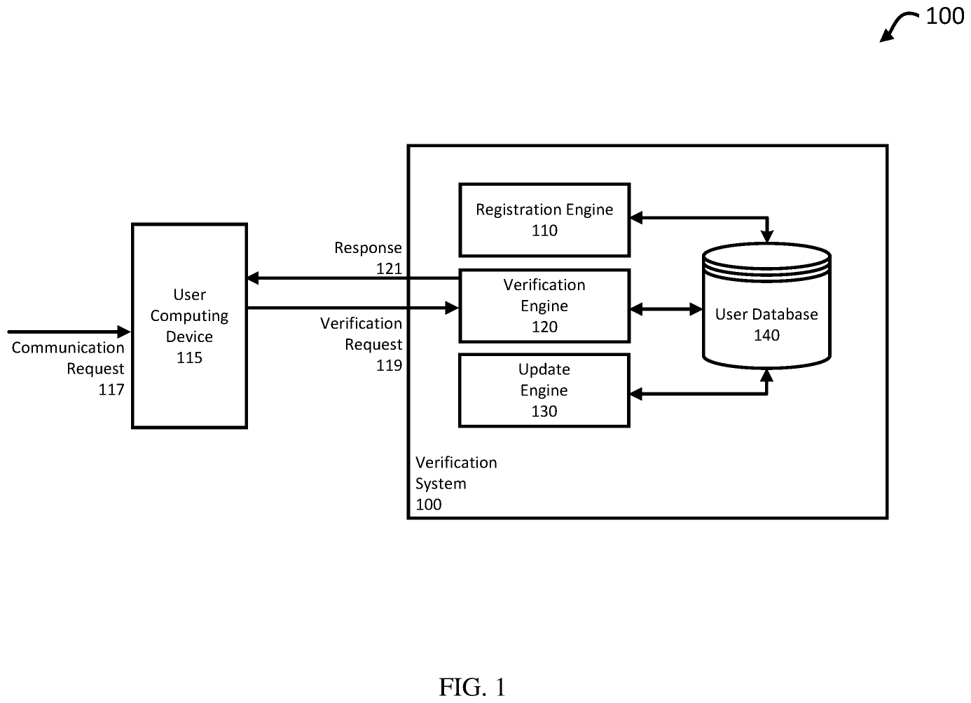

FIG. 1 is a block diagram of the example verification system 100, according to aspects of the disclosure. The verification system 100 can include a registration engine 110, a verification engine 120, and an update engine 130. The verification system 100 can also include a user database 140 for storing data in memory, including mappings of users to source identifiers, as described herein. A user may be a person or entity that owns, administers and/or otherwise controls a domain name and desires to map its own source identifiers to the domain name. In this manner, users of the system 100 can include registered users registered to the system. Users can also include service users corresponding to user computing devices sending verifications requests to the system 100. In some examples, a user computing device may receive a communication from a registered user and send verification requests for verifying incoming communications, as described herein.

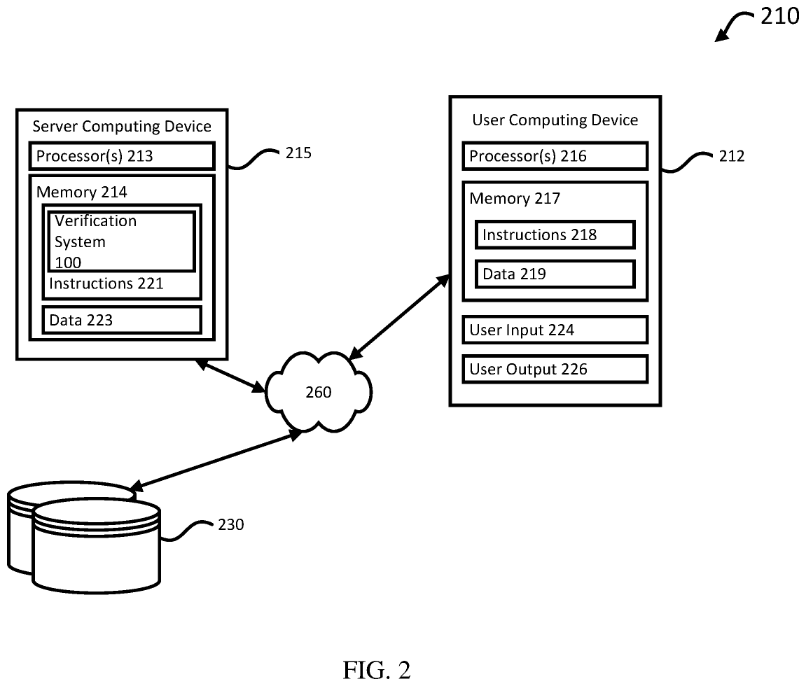

As also described herein with reference to FIG. 2, the verification system 100 can be at least partially implemented on a user computing device 115, such as a smartphone, tablet, laptop, smart TV, personal computer, etc. In some implementations, the verification system is at least partially implemented on one or more server computing devices that are configured to communicate with a user computing device 115.

In some examples, the system 100 is configured to receive verification requests from computing devices not associated with any service user or registered user of the system 100. The verification system 100 can be at least partially implemented on devices that are not configured for user input or output, but instead are configured to automatically receive and send data, for example to other devices of a network. An example of such a device can be a network node acting as an intermediary between networks of devices across a computing platform. In those examples, the verification system 100 can be configured to verify incoming communications to the device, verify whether the communication is received from a source known to the system 100, and indicate to the device whether the incoming data should be ignored or acted on. In the aforementioned examples, the verification process can be employed in a manner as described elsewhere in the present disclosure, relying on a process of registering users or devices in order to associate source identifiers with those users or devices.

The user computing device 115 can receive an incoming communication request 117. The communication request 117 can be a message or data sent to the user computing device 115 indicating that another device, called a source computing device in this specification, is attempting to communicate with the user computing device 115. Examples of communication requests can include incoming phone calls, text messages to the user computing device, and/or messages on a computing platform sent from a user account of the computing platform. For example, a communication request can be a direct message from a user account of a social media platform, in which the message is sent through an application on the user computing device 115, such as a web browser or a software mobile application associated with the platform and installed on the user computing device 115.

The communication request 117 can include a source identifier identifying the source computing device from which the communication request 117 is sent. Before the verification system 100 receives and processes the source identifier as described herein, the source identifier is verified. As an example, the user computing device 115 can receive a source identifier including a phone number and a caller ID. The caller ID can be a text string that appears on a display of a user computing device when a call is received. The caller ID ostensibly identifies the source computing device, however as described herein, a phone company or other manager for different forms of communication such as phone calls typically relies on information provided by third parties about phone numbers at face value without conducting further review to confirm. And, even that assumes that such information is provided to the phone company in the first place.

The user computing device 115, in response to receiving the communication request 117, can send a verification request 119 to the verification system 100. The user computing device 115 in some examples is configured to automatically send the request 119 when receiving a communication request from a source that the user computing device 115 has not previously verified via the verification system 100. In those examples, the system 100 can be installed on the device 115 after appropriate installation permissions are received through the operating system of the device 115, for example permitting the system 100 to receive information regarding communication requests to the device 115. In other examples, the device 115 may communicate with the verification system 100 stored separately from the device 115, such as on a remote server.

In other examples, the user computing device 115 can include a display and a user interface for receiving user input and displaying information. The user computing device 115 can send a prompt through the user interface requesting input as to whether or not to send the communication request 117 for verification. In response to user input, e.g., touch input on a button, the user computing device can send the verification request 119 to the verification system 100. In this way, the user computing device 115 may be configured so that verification requests 119 of communication requests 117 may be made manually.

The verification engine 120 can be configured to receive the verification request 119, which can include the source identifiers from the communication request 117 sent to the user computing device 115. The verification engine 120 can be configured to query the user database 140 to identify a source identifier mapped to a user previously registered with the verification system 100 that matches the source identifier from the communication request 117. The user database 140 can store one or more mappings. A mapping refers to data that associates one or more source identifiers, e.g., one or more phone numbers, with a user registered with the verification system 100. The registration engine 110 can be configured to register new users of the verification system 100, while the update engine 130 can be configured to update source identifiers mapped to existing users after the users have been registered.

If the verification engine 120 determines that the source identifier from the communication request 117 matches a source identifier mapped to a user in the user database 140, then the verification engine 120 can send a response 121 to the user computing device 115 indicating that the source identifier has been verified as belonging to the mapped user. The verification engine 120, as part of sending the response 121, can also verify whether a name provided with the source identifier of the communication request 117 matches a name on record with the mapped user. In some examples, if the user computing device 115 accepts the communication request 117 as verified, the user computing device 115 can thereafter allow unrestricted communication between it and the verified source computing device.

If the verification engine 120 determines that the source identifier of the communication request 117 does not match a source identifier mapped to the user database 140, then the verification engine 120 can send the response 121 to indicate that a match was not found and the number could not be verified. The user computing device 115 can be configured to automatically reject the communication request 117 if the response 121 indicates a match was not found, and/or provide a prompt through a user interface requesting input to reject or allow the communication request 117 to go through.

In some examples, communication requests come in the form of direct messages to the user computing device 115, through a social media platform. The message can be received, for example, through a dedicated application corresponding to the social media platform, or from a web browser, such as a mobile web browser for a mobile device. The verification engine 120 can be at least partially implemented as a plugin or add-on software to a software application for a social media platform, for example built using one or more application programming interfaces (APIs) and/or one or more software development kits (SDKs) provided by the social media or other platform. The verification engine 120 can be installed in response to receiving user input allowing the installation, and can be removed at any time upon further user input indicating a request to remove/uninstall the verification engine 120 from the device. The verification engine 120 can be configured to identify account information for an account of the platform identified as sending the direct message to a user accessing the platform from an application or web browser with the plugin or add-on software installed. The verification engine 120 can determine whether the platform account information matches a source identifier mapped to a registered user of the system 100. In this example, the registered user of the system 100 may have sent data to the system 100 to map one or more social media accounts to the registered user, including an account for the platform from which the communication request was received.

In response to determining that the platform account for the communication request matches an account mapped to the registered user, the verification engine 120 can permit the message to be sent. In response to determining that platform account for the communication request does not match any account mapped to a registered user of the system 100, the verification engine 120 can be configured to prompt the user computing device 115 with a warning with an option to receive the communication anyway, automatically delete the message with or without a warning, or block the source platform account altogether.

In some examples, the system 100 is configured to facilitate automatic communication between devices of a network. In these examples, the source identifiers for each device can be an address or identifier unique to the device in the context of the network. Communication requests in this example can be data transmitted back-and-forth between devices on the network. Instances of the system 100 can be implemented across the multiple devices, and/or be implemented on one or more devices configured to monitor communication to-and-from the individual devices. As another example, automated devices implementing cellular technology, e.g., for call or text communication, can provide open access to services provided by the device, while deterring spam communication from bots or other malicious actors from interfering with the service provided.

In one implementation of the above referenced examples, when a device of the network receives a message, e.g., some data, from another device on the network that has not previously communicated with the subject device, the system 100 can verify the sending device according to aspects of the disclosure described herein, to verify whether the sending device is permitted to communicate with the subject device. Because a digital certificate corresponding to an entity of the sending device is only required during an initial registration process to register the user to the system 100, the sending device thereafter does not require the digital certificate to send data and be verified by the receiving device. In this way, the verification process is simplified and also reduces the need for either device to have access to sensitive information, such as private keys.

For example, a device can be implemented to receive sensor data from a remote weather station measuring atmospheric or weather conditions at a remote physical location. The weather station device can provide data about conditions at a physical location. The weather station device can receive communication requests to receive up-to-date weather information from devices previously registered with the verification system as described herein, and reject communication requests from unregistered devices. After the initial registration and domain verification process is complete for a registered device, thereafter the weather station device can rely on the previous registration and verification provided by the system 100, instead of requiring and managing a username/password system, or implementing a cryptographic protocol to verify devices sending communication requests.

In addition or as an alternative, the weather station device can be registered with the verification system 100 as described herein, and automatically send out weather information, e.g., through text, to other computing devices. The other computing devices can verify that the weather station device is registered with the system 100, and allow incoming communication requests from the weather station device including the weather information or other data.

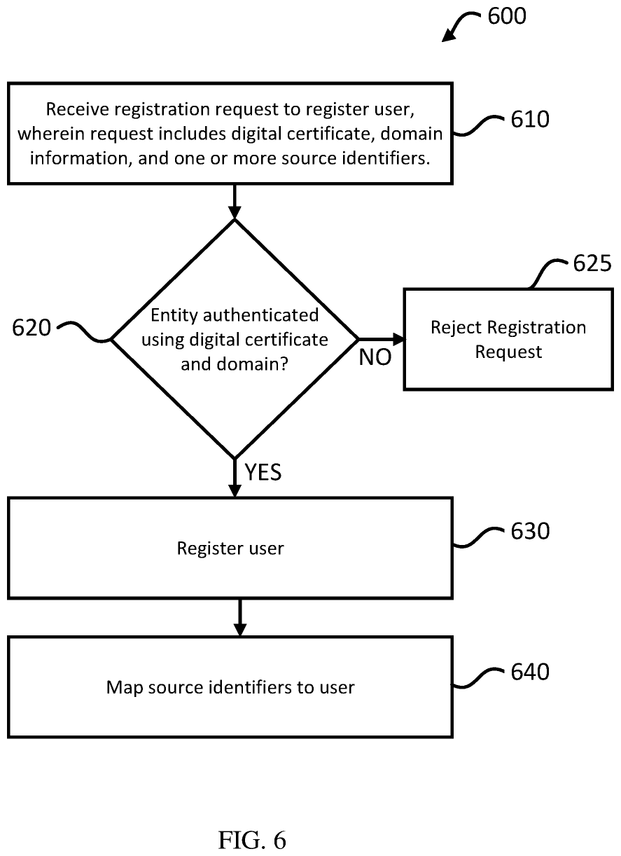

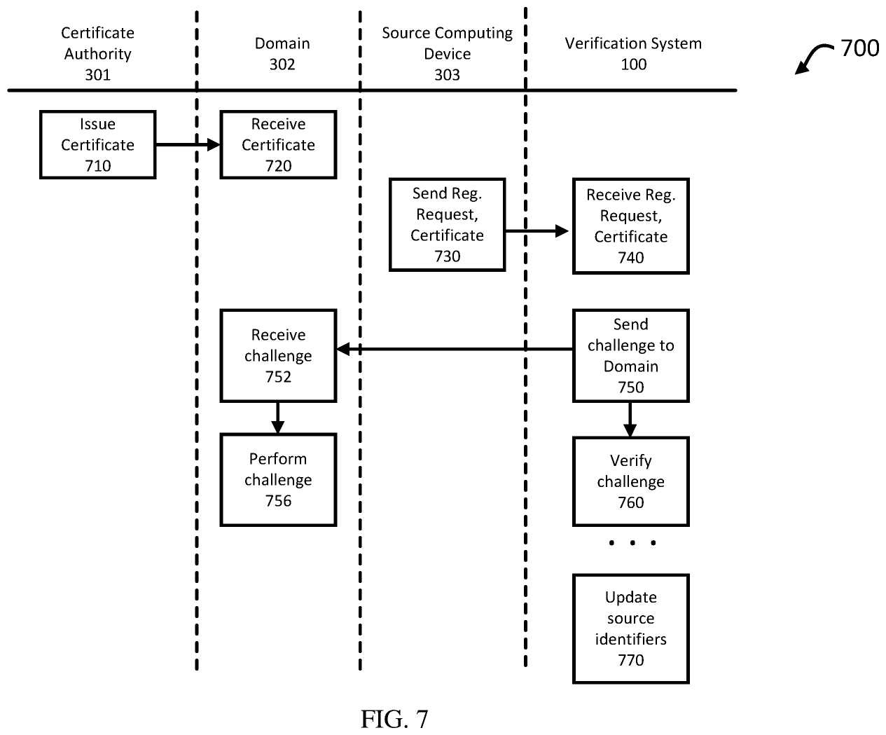

Users of the verification system 100 can be any type of entity, such as an individual, an organization, a business, or a collection of automated software configured to interact with the verification system 100. Before registering a user, an entity can communicate with the verification system 100 by creating a user account and creating a registration request, for example through an interface provided by the verification system 100, such as a website. In the case of an organization or an entity that is not a person, the user account can be created by an individual associated with the entity, such as a technical administrator or other designated individual. In some examples, a user account of the system 100 can be a registered account, unregistered account, or a service account. A registered account can be an account that has been successfully registered, for example as described herein with reference to FIGS. 6-7. An unregistered account can be an account from which a device logged into the unregistered account sends a registration request to the system 100. If and when the unregistered account passes the registration process as described herein, the system 100 can update the status of the account to “registered.”

A service account can be an account that is neither registered nor unregistered with the system 100. A device logged into a service account can send verification requests to the system 100 in response to incoming communication requests. The service account is not associated with a user that is registered with the system or in the process of becoming registered with the system, but may instead be associated with an entity using the verification system 100 to verify incoming communications.

As described herein with reference to FIGS. 6-7, the verification system 100 can be configured to register new users and associate one or more source identifiers to each user. For example, an entity, such as a business, may register with the system 100 and associate different phone numbers as associated with the entity. The verification system 100, for example through the registration engine 110, can perform a process to register the entity as a user of the system, for example as described with reference to FIGS. 6-7. As part of the registration process, the entity provides a digital certificate corresponding to a domain maintained by the entity.

As an example, the digital certificate can be a TLS certificate issued by a certificate authority or other trusted party. A certificate authority can refer to any entity, including individual, organization, or automated software/hardware, which is trusted to issue digital certificates. Certificate authorities can manage a database of keyfiles or other data structures for issuing and managing cryptographic keys issued to entities corresponding to various digital certificates issued by the authority. Certificate authorities can also be any of a variety of decentralized authorities, such as systems for generating certificates using blockchain or other distributed technology. A domain refers to one or more computing devices sharing a common range of network addresses and generally maintained or controlled by a common entity.

After the initial registration, the system 100 can continue to interact with the user, for example through a user account and user interface, to receive updates regarding source identifiers to map to the user. The update engine 130 for the system 100 can be configured to receive incoming update requests from user computing devices associated with registered users of the system 100. User computing devices can be associated with users of the system 100 in a number of different ways. The system 100 can provide a user account upon registration of an entity as a user of the system 100. The system 100 can determine whether incoming update requests or other data is received from a particular user of the system 100, based on whether the data is received from a user computing device logged in with the matching user account for the user.

FIG. 2 is a block diagram of an example computing environment 210 in which the example verification system 100 is implemented, according to aspects of the disclosure. The system 100 can be implemented on one or more devices having one or more processors in one or more locations, such as in server computing device 215.

User computing device 212 and the server computing device 215 can be communicatively coupled to one or more storage devices 230 over a network 260. The user computing device 212 can correspond to a registered user, an unregistered user, or a service user as described herein with reference to FIG. 1. In some examples, the user computing device 212 is not associated with any particular user, but instead is configured to automatically send and receive data according to one or more processes. The storage device(s) 230 can be a combination of volatile and non-volatile memory, and can be at the same or different physical locations than the computing devices 212, 215. For example, the storage device(s) 230 can include any type of non-transitory computer readable medium capable of storing information, such as a hard-drive, solid state drive, tape drive, optical storage, memory card, ROM, RAM, DVD, CD-ROM, write-capable, and read-only memories.

The server computing device 215 can include one or more processors 213 and memory 214. The memory 214 can store information accessible by the processor(s) 213, including instructions 221 that can be executed by the processor(s) 213. The memory 214 can also include data 223 that can be retrieved, manipulated or stored by the processor(s) 213. The memory 214 can be a type of non-transitory computer readable medium capable of storing information accessible by the processor(s) 213, such as volatile and non-volatile memory. The processor(s) 213 can include one or more central processing units (CPUs), graphic processing units (GPUs), field-programmable gate arrays (FPGAs), and/or application-specific integrated circuits (ASICs).

The instructions 221 can include one or more instructions that when executed by the processor(s) 213, causes the one or more processors to perform actions defined by the instructions. The instructions 221 can be stored in object code format for direct processing by the processor(s) 213, or in other formats including interpretable scripts or collections of independent source code modules that are interpreted on demand or compiled in advance. The instructions 221 can include instructions for implementing the verification system 100 consistent with aspects of this disclosure. The verification system 100 can be executed using the processor(s) 213, and/or using other processors remotely located relative to the server computing device 215.

The data 223 can be retrieved, stored, or modified by the processor(s) 213 in accordance with the instructions 221. The data 223 can be stored in computer registers, in a relational or non-relational database as a table having a plurality of different fields and records, or as JSON, YAML, proto, or XML documents. In some examples, the data 223 can be stored in one or more blockchains, or in a blockchain-based database, combining traditional database and blockchain functionality to manage data corresponding to data distributed across one or more blockchains. The data 223 can also be formatted in a computer-readable format such as, but not limited to, binary values, ASCII or Unicode. Moreover, the data 223 can include information sufficient to identify relevant information, such as numbers, descriptive text, proprietary codes, pointers, references to data stored in other memories, including other network locations, or information that is used by a function to calculate relevant data. In some examples, the data 223 can include data corresponding to one or more user accounts, one or more source identifiers, and/or data for mapping source identifiers to various user accounts as described herein. The data 223 can be at least partially stored in the database 140, and the database 140 can include other data like the data 223 that is be stored across one or more storage devices at one or more locations.

The user computing device 212 can also be configured similar to the server computing device 215, with one or more processors 216, memory 217, instructions 218, and data 219. The user computing device 212 can also include a user output 226, and a user input 224. The user input 224 can include any appropriate mechanism or technique for receiving input from a user, such as keyboard, mouse, mechanical actuators, soft actuators, touchscreens, microphones, and sensors.

The server computing device 215 can be configured to transmit data to the user computing device 212, and the user computing device 212 can be configured to display at least a portion of the received data on a display implemented as part of the user output 226. The user output 226 can also be used for displaying an interface between the user computing device 212 and the server computing devices 215. The user output 226 can alternatively or additionally include one or more speakers, transducers or other audio outputs, a haptic interface or other tactile feedback that provides non-visual and non-audible information to the user of the user computing device 212.

Although FIG. 2 illustrates the processors 213, 216 and the memories 214, 217 as being within the respective computing devices 215, 212, components described in this specification, including the processors 213, 216 and the memories 214, 217 can include multiple processors and memories that can operate in different physical locations and not within the same computing device. For example, some of the instructions 221, 218 and the data 223, 219 can be stored on a removable SD card and others within a read-only computer chip. Some or all of the instructions and data can be stored in a location physically remote from, yet still accessible by, the processors 213, 216. Similarly, the processors 213, 216 can include a collection of processors that can perform concurrent and/or sequential operation. The computing devices 215, 212 can each include one or more internal clocks providing timing information, which can be used for time measurement for operations and programs run by the computing devices 215, 212.

The server computing device 215 can be configured to receive requests to process data from the user computing device 212, such as verification requests, registration requests, and/or update requests as described herein. For example, the environment 210 can be part of a computing platform configured to provide a variety of services to users, through various user interfaces and/or Application Programming Interfaces exposing the platform services.

The devices 212, 215 can be capable of direct and indirect communication over the network 260. The devices 215, 212 can set up listening sockets that may accept an initiating connection for sending and receiving information. The network 260 itself can include various configurations and protocols including the Internet, World Wide Web, intranets, virtual private networks, wide area networks, local networks, and private networks using communication protocols proprietary to one or more companies. The network 260 can support a variety of short- and long-range connections. The short- and long-range connections may be made over different bandwidths, such as 2.402 GHZ to 2.480 GHZ (commonly associated with the Bluetooth® standard), 2.4 GHZ and 5 GHZ (commonly associated with the Wi-Fi® communication protocol); or with a variety of communication standards, such as the LTE® standard for wireless broadband communication. The network 260, in addition or alternatively, can also support wired connections between the devices 212, 215, including over various types of Ethernet connections.

Although a single server computing devices 215 and user computing device 212 are shown in FIG. 2, it should be understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device, and any combination thereof.

### Example Methods

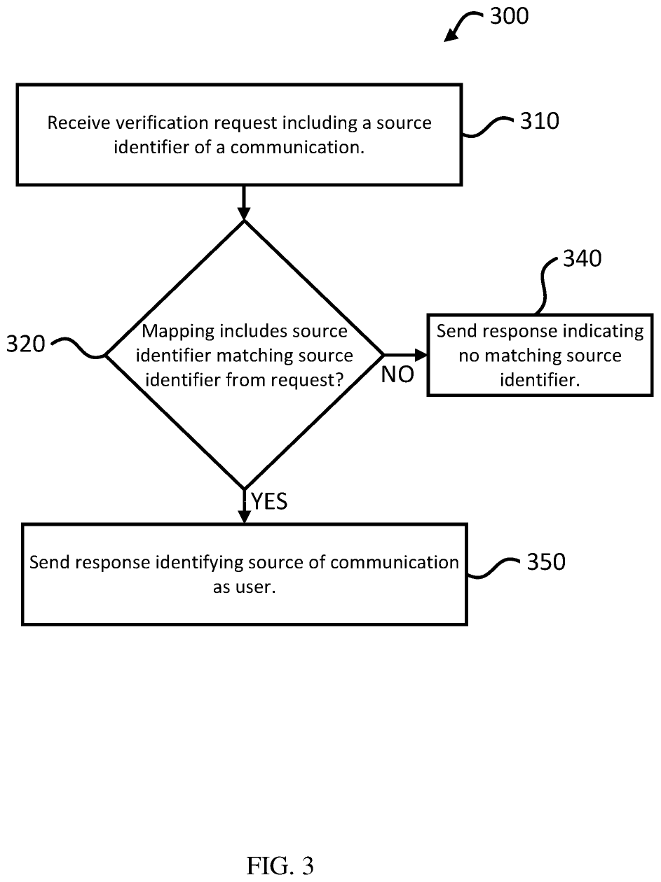

FIG. 3 is a diagram showing an example process for verifying the source of an incoming communication, according to certain aspects of the disclosure. A verification system including one or more processors, such as the verification system 100 of FIGS. 1-2, can perform the process 300. The system receives a verification request that includes a source identifier, according to block 310. The source identifier can be a source identifier as described herein with reference to FIGS. 1-2. As described herein, the system can receive the verification request from a user computing device receiving an incoming communication request. In some examples, the verification system is implemented on the device receiving a communication request that prompts the request for verification, while in other examples the verification system is implemented on one or more devices separate from one or more other devices receiving the communication for verification. The verification request can include a communication source identifier received by a device along with the communication request. For example, if the incoming communication request is a phone call, then the communication source identifier received by the system can include a phone number and a caller ID for the phone number.

The system determines whether a mapping of source identifiers to registered users includes a mapped source identifier matching a communication source identifier from the verification request, according to block 320. As part of this determination, the verification system 100 can be configured to query the user database 140 to determine whether the communication source identifier matches any source identifier currently stored by the user database 140. The query and look-up can be implemented according to any of a variety of different techniques for database querying.

If the system identifies a match between a mapped source identifier and the communication source identifier, the system can look up the user information for a user mapped to the source identifier. In the example in which the source identifier includes a phone number, the system can identify the user mapped to that phone number. The user mapped to the phone number is an entity registered with the system, according, for example, to the process 600 as described herein with reference to FIG. 6.

If the system determines that the source identifier in the mapping does match the communication source identifier (“YES”), then the system sends a response to the user computing device identifying the source of communication as the user mapped to the matching source identifier, according to block 350. The computing device from which the verification request originated can receive the response, and perform any one of a number of actions. For example, the computing device can automatically accept the communication request, after receiving the response from the verification system verifying the identity of the source of the request. In the example of a phone call, the computing device can receive the response, and accept the phone call. In other examples, the response identifying the source of communication can cause the user computing device receiving the communication request to generate a prompt on a user interface. The prompt can provide information related to the source of the communication request, and/or indicate that the communication request has been successfully verified as a previously registered user of the system. Further, in some examples, the prompt may provide the user with the option of affirmatively accepting the communication request.

If the system determines that the source identifier in the mapping does not match the communication source identifier (“NO”), then the system sends a response to the user computing device indicating there was no matching source identifier, according to block 340. In this case, the computing device receiving the response can automatically decline the communication request. In addition or alternatively, the computing device, after receiving the response, can provide information to a user interface indicating that a match was not successful, and that the identity of the source of the communication request could not be verified. In still further variations, upon indicating on the user interface that the source could not be verified, an option to accept the communication request may be made available to the user.

In some examples, the system can implement any of a variety of different techniques, e.g., using machine learning, for automatically comparing the non-matching source identifier with one or more registered source identifiers previously registered with the system. For example, if a rejected communication request included a caller ID similar to that of a caller ID of a registered entity, the system can identify the closest matching caller ID and flag the rejected communication request as an attempt to fake a communication request from the registered entity.

The system can implement any of a number of techniques for textual language processing, e.g., one or more machine learning models trained to predict one or more source identifiers most similar to the source identifier of the rejected communication, for example using predetermined or learned similarity functions, such as a distance function between the text of the compared source identifiers.

The system can perform a number of actions in response to identified similar registered source identifiers, for example alerting the registered entity having a similar source identifier of the attempted impersonation, and/or providing information to the computing device receiving the communication request to warn a user of the attempted impersonation. In some examples, the system can prompt the user to confirm whether the provided registered source identifiers appear similar or dissimilar to the unregistered source identifier. The response from the user can be used as a classification label for the pair of unregistered and registered source identifiers, which can be used as part of additional training to update model parameters values of the one or more machine learning models to provide more accurate output for future classifications or predictions.

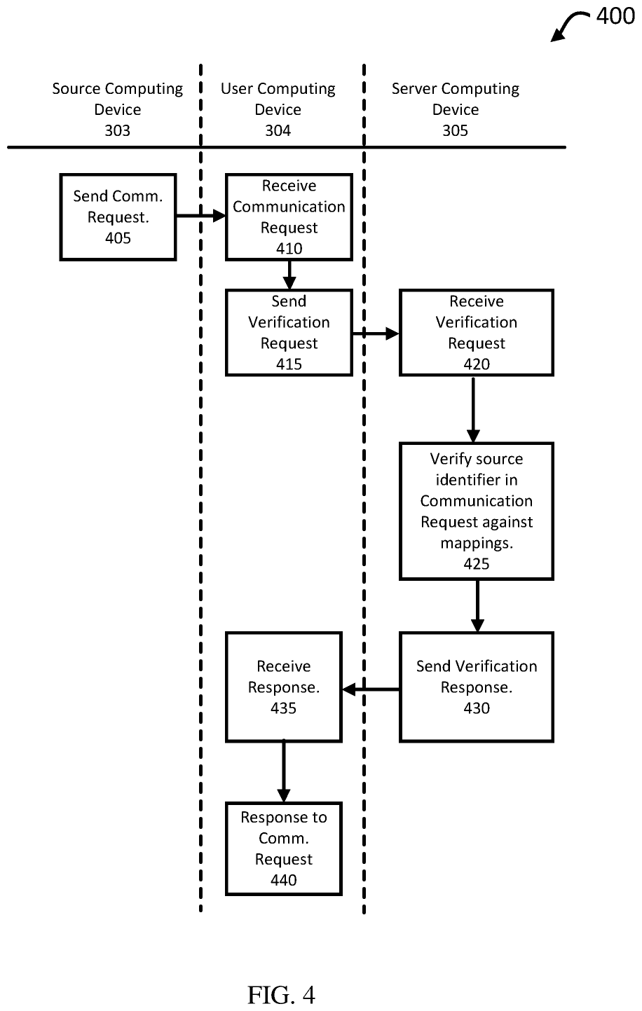

FIG. 4 is a diagram showing an example process 400 for verifying the source of an incoming communication request when the verification system is implemented on a server computing device, according to certain aspects of the disclosure. A user computing device 304 can be configured to operate as a client to a server computing device 305 hosting the verification system. For example, the user computing device 304 can include software that has been configured to receive incoming communication requests to the device 304, and generate verification requests to the server computing device 305, for example automatically or in response to user input.

In an implementation of the process, a source computing device 303 sends a communication request according to block 405. A user computing device 304 receives the communication request according to block 410, and sends a verification request to verify the source of the communication request, according to block 415.

As described herein with reference to FIGS. 1-3, the server computing device 305 implementing the verification system 100 can compare source identifiers of registered users of the system 100 against the source identifier received as part of the communication request. The server computing device 305 receives the verification request, according to block 420, and verifies the source identifier received in the communication request against source identifiers mapped to registered users in the database of the system, according to block 425.

The server computing device 305 sends a response to the user computing device 304 indicating whether or not the source of the communication request has been verified, according to block 430. The user computing device 304 receives the response, according to block 435, and responds to the communication request based on the response received, according to block 440. The response of the user computing device 304 to the verification response can depend on whether or not the server computing device 305 identified a registered user matched to the source identifier, as described herein with reference to FIG. 3.

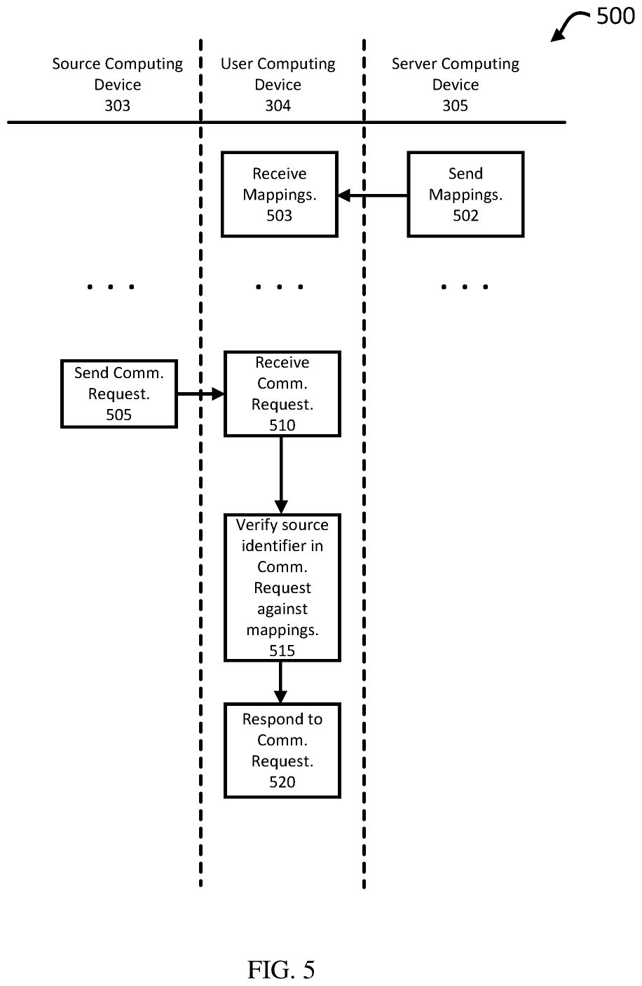

FIG. 5 is a diagram showing another example process 500 for verifying the incoming communication request when the verification system is implemented on a user computing device, according to aspects of the disclosure. In FIG. 5, the user computing device 304 at least partially implements the verification system 100. The user computing device 304 can perform the process 300 to verify the source of an incoming communication request.

The server computing device 305 can send mappings and/or other data related to source identifiers and registered users periodically to the user computing device 304, which the user computing device can receive, according to blocks 502 and 503. As examples, the server computing device 305 can send updated mappings to the user computing device 304 periodically, e.g., once a day, in response to updates to the mappings stored in a user data store, or in in response to a request from the user computing device 304 for updated mappings. In some implementations, the user computing device 304 receives a subset of mappings which are maintained by the server computing device 305. For example, the user computing device 304 can be configured to request mappings only for some users, for example based on user input to the device 304. The user computing device 304 can provide an interface for selecting source identifiers for only some users to be loaded on the device 304, for example based on preferences indicated through user input.

In implementations described herein with reference to FIG. 5, the verification system 100 can be implemented on devices with less memory than in implementations in which the verification system is implemented as part of a server. The computing device 304 in these examples can receive a subset of approved sources of communication, and be configured to automatically block other communication requests with source identifiers not matching the subset of approved sources.

For example, after the source computing device 303 sends a communication request, according to block 505, the user computing device 304 can receive the communication request, according to block 510, and verify the source identifier in the communication request, according to block 515. The user computing device 304 can respond to the communication request, as shown in block 520, based on whether the source identifier was verified, according to block 515.

FIG. 6 is a diagram showing an example process 600 for registering an entity and updating source identifiers on the verification system, according to certain aspects of the disclosure.

The system receives a registration request to register an entity as a user, according to block 610. A computing device can access a web page or other interface for communicating with the verification system, and create a user account. Initially, the user account is unverified. The registration request includes a digital certificate, domain information for a domain associated with the digital certificate, and one or more source identifiers. The registration request can be sent via a computing device of an entity purporting to have been issued the digital certificate.

The system determines whether the entity from which the registration request is received is the same entity that has been issued the digital certificate, according to block 620. To determine whether the entity from which the registration request is received is the same entity that has been issued the digital certificate, the system can be configured to require the entity to respond to some challenge that generally can only be performed by an entity that has been issued the digital certificate. For example and as shown in FIG. 7, the system can issue a challenge string in response to the registration request. A challenge string can be some data, e.g., a text string that is generated by the verification system and used to determine whether the entity of the unverified user account is the entity identified in the digital certificate. In other examples, other forms of data can be used for the challenge, such as an image or web link. The system can cause the computing device from which the registration request was sent from, to generate a prompt with instructions for updating one or more records at a domain specified in the domain information with the challenge string.

For example, one or more devices for the domain can maintain domain name system (DNS) records. The entity, through the user interface of a requesting computing device, can be prompted to update one or more records, e.g., DNS TXT records, with the challenge string. The system can determine, by communicating with the DNS of the specified domain, whether one or more records of the DNS have been updated in accordance with the challenge string in response to the instructions from the system. Because the domain is presumed to be managed by the entity identified in the digital certificate, as it should be, if the system determines that one or more records have been updated with the challenge string, then the system determines that the entity from which the registration request is received is the same entity that has been issued the digital certificate. The successful completion of this process satisfies the requirements for registering the entity as a registered user, and the system registers the user, according to block 630. For example, the system marks the previously unverified user account as verified.

As another example, the challenge can be to add or update a page or file of a website corresponding to the received domain with the issued challenge string. In other examples, the challenge can be a combination of different challenges, e.g., to update a DNS record and to add a page or file with the issued challenge string.

If the system cannot authenticate the user, e.g., because the challenge was not successfully completed, then the system rejects the registration request, according to block 625.

Upon satisfactory completion of registration, the system maps the source identifiers to the now registered user, according to block 640. Thereafter, the system can receive update requests from a user computing device to add, remove, or modify source identifiers corresponding to the user.

One advantage of the system is that it does not require use of the digital certificate to update source identifiers for a registered user after the registration process is complete. For updates made after the user is registered, the system can verify whether the user account of the registered user is logged into the device sending a request to update source identifiers. In some examples, the system can associate one or more user computing devices as related to a user account for the registered user. In such arrangements, the system can determine whether an update request for source identifiers for the registered user was received from one of the associated computing devices, and in response, update the source identifiers per the request.

FIG. 7 is a flowchart of an example process 700 for registering an entity with a verification system, according to certain aspects of the disclosure. The verification system 100 of FIGS. 1-2 can perform the process 700.

A certificate authority 301 issues a digital certificate to domain 302, according to block 710. The domain 302 can include a computing device from which a registration request is sent. The domain 302 receives the certificate, according to block 720. For example, a device in the domain 302 can be configured to receive the digital certificate, and also be responsible for updating DNS records, as necessary.

A source computing device 303 can send a registration request and certificate to the verification system 100, according to block 730. The system 100 receives a registration request to register a user, according to block 740. The request can include a digital certificate, data identifying a domain, and one or more source identifiers. The system sends a challenge to the domain, according to block 750.

One or more devices for the domain 302 can receive the challenge, according to block 752. The one or more devices for the domain 302 can perform the challenge, according to block 756. As described herein with reference to FIG. 6, the verification system can send a challenge string and check whether a DNS TXT record is thereafter updated consistent with the challenge string, as part of verifying the challenge according to block 760. The system updates source identifiers mapped to the user, according to block 770. The system can update source identifiers provided as part of the registration request, and/or source identifiers provided later in time, as part of an update request. As described herein with reference to FIG. 6, the system determines whether the computing device sending the update request is associated with the registered user for which source identifiers are being updated. The system can determine, for example, that the registered user's account is logged into the computing device, and/or that the computing device has been predetermined to be associated with the registered user.

In another aspect, a verification system of the present disclosure is adapted to verify the source, i.e., owner of technologies implemented on and otherwise incorporated into a blockchain. The verification system may be verification system 100, for example, as described above. For the sake of brevity, the following embodiments are described with reference to verification system 100. In some embodiments, verification system 100 may be used to verify a source of a non-fungible token, also referred to herein as “NFT”, on a blockchain. NFTs can be any kind of media, including images, audio or text files. As further background, NFTs can be absolutely one of a kind in content, where there are no duplicates. In other cases, NFTs can be one of a kind with a set quantity of duplicates that may be distinguished by a serial number.

In one embodiment, a user in the form of a content creator seeks to make an NFT with properties that irrefutably demonstrate that the NFT was made by such creator. To do so, the user uploads the content to be issued as an NFT, such as a media file, to the verification system 100. In conjunction with the upload of the content, the user also uploads data representative of a domain name. When the verification system 100 receives the request to create an NFT on the creator's behalf along with the domain information, the system processes the domain name and sends a challenge to the user, a process described elsewhere in the present disclosure and shown commencing from block 750 in FIG. 7. This is followed by the steps indicated by blocks 752, 756 and 760 in FIG. 7, where the user performs the challenge to confirm ownership of the domain and the verification system determines whether the challenge is performed successfully. When the domain is verified by the verification system through the challenge issued to the user, the verification system may create an attribute or “signature” that attributes the creator of the NFT to the NFT itself, the signature being embedded into the meta data of the NFT in the form of an encrypted token. In some examples, the domain authentication can be visually watermarked into the NFT in the case of images and videos via plain text and/or a two-dimensional barcode.

In the embodiment described above, the creator is the owner of the domain name associated with the NFT. As part of the process of creating a signature that is embedded into the NFT's meta data, verification system 100 may embed encrypted data in the associated meta data of the NFT. Such encryption may be asymmetric encryption. Through such processing by the verification system to create an NFT, the NFT is publicly verifiable as being attributed to the now verified user/domain owner. In particular, when the verification system employs asymmetric encryption, a private key and a public key are created, with the private key being used to encrypt some or all the contents of the data that becomes the NFT. The private and public keys are different but complement one another as a unique pair. In particular, the signature for the private key is different from the key used to prove its source or read its contents, and only the creator ever has access to the private key. The private key may only be created by the verification system and is not publicly accessible, while the public key may be made available to the public. Both the private key and the public key may be stored separately from the NFT itself. For example, the private key may be stored in a secure storage medium controlled by the owner of the verification system completely restricted from access by any third party, while the public key may be accessible through a secure website administered by the owner of the verification system. A secure website may be one that has been verified by a certificate authority as being the entity it claims to be, for example, by confirming its digital certificate.

To illustrate one example of how a user may retrieve an NFT and know that its source is who it appears to be on its face, the user will obtain the public key from a secure website owned by the entity that operates the verification system that created the NFT. Then, when the user seeks to decrypt the contents of the NFT, for example, by accessing a link to the NFT on the same website, the user will know definitively whether the NFT was in fact issued by the verification system. In particular, if the contents are decrypted, the NFT must have been issued by the verification system on behalf of the domain owner identified in the NFT. This is because the user already knows that the owner of the website, e.g., owner of verification system, provided the public key, and only the same owner can have the complementary private key. If the contents cannot be decrypted with the public key, then the user knows that the NFT in question was not encrypted by the verification system 100's private key, therefore it was not issued by the verification system and is therefore not authentic.

The ability to verify the source of NFTs may also be employed in indirect contexts. For example, in a video game that includes an ability to acquire objects and other items, such objects and items may each be associated with an NFT. Specifically, the verification system of the present disclosure may be used to control the number of items based on their unique identity as NFTs, adding a new dimension to such features in the video game.

Although the above embodiments and examples thereof relate to NFTs in particular, this concept may be applied in many other contexts as well. For example, a bar code may be included with a business card, where the contents of the bar code may be signed by the verification system so that a reader of the business card is able to verify its source.

In other embodiments, NFTs may be mapped to a domain, similar to other information such as phone numbers and website URLs as described elsewhere in the present disclosure. For example, a verification system of the present disclosure may include a listing of domains and associated information, where one or more of those domains include at least one NFT associated with the domain.

Aspects of this disclosure can be implemented in digital circuits, computer-readable storage media, as one or more computer programs, or a combination of one or more of the foregoing. The computer-readable storage media can be non-transitory, e.g., as one or more instructions executable by a cloud computing platform and stored on a tangible storage device.

While operations shown in the drawings and recited in the claims are shown in a particular order, it is understood that the operations can be performed in different orders than shown, and that some operations can be omitted, performed more than once, and/or be performed in parallel with other operations. Further, the separation of different system components configured for performing different operations should not be understood as requiring the components to be separated. The components, modules, programs, and engines described can be integrated together as a single system, or be part of multiple systems.

In this specification the phrase “configured to” is used in different contexts related to computer systems, hardware, or part of a computer program, engine, or module. When a system is said to be configured to perform one or more operations, this means that the system has appropriate software, firmware, and/or hardware installed on the system that, when in operation, causes the system to perform the one or more operations. When some hardware is said to be configured to perform one or more operations, this means that the hardware includes one or more circuits that, when in operation, receive input and generate output according to the input and corresponding to the one or more operations. When a computer program, engine, or module is said to be configured to perform one or more operations, this means that the computer program includes one or more program instructions, that when executed by one or more computers, causes the one or more computers to perform the one or more operations.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description should be taken by way of illustration rather than by way of limitation of the subject matter defined by the claims. In addition, the provision of the examples described herein, as well as clauses phrased as “such as.” “including” and the like, should not be interpreted as limiting the subject matter of the claims to the specific examples; rather, the examples are intended to illustrate only one of many possible implementations. Further, the same reference numbers in different drawings can identify the same or similar elements.

1. A system comprising:
one or more processors coupled to memory, the one or more processors configured to:
receive a verification request to verify the source of a communication between a source computing device and a recipient computing device, the verification request comprising a second source identifier;
determine, through accessing of a database, whether the database includes a first source identifier from among one or more user source identifiers stored in the database, the first source identifier matching the second source identifier; and
when the database includes the first source identifier:
identify the user mapped to the first source identifier, wherein the first source identifier and the user are mapped using a digital certificate associated by the system with the user; and
send a response to the verification request to the recipient computing device, the response identifying the source of the communication as the user.

2. The system of claim 1,
wherein the first source identifier comprises a first name mapped to the user;
wherein the second source identifier comprises a second name; and
wherein in determining whether the database comprises a first source identifier matching the second source identifier, the one or more processors are further configured to determine whether the second name of the second source identifier matches the first name mapped to the user.

3. The system of claim 2,
wherein the second source identifier comprises a phone number; and
wherein to determine whether the database comprises a first source identifier matching the second source identifier, the one or more processors are further configured to determine whether the one or more user source identifiers comprise a phone number matching the phone number of the second source identifier.

4-5. (canceled)

6. The system of claim 1,
wherein the digital certificate is further associated with a domain of one or more computing devices, and
wherein the one or more processors are further configured to generate a mapping between the first source identifier and the user, wherein to generate the mapping, the one or more processors are configured to:
receive a registration request to register the user, the registration request comprising the digital certificate and data identifying the domain; and
authenticate the user using the digital certificate and the domain.

7. The system of claim 6, wherein the one or more processors are further configured to:
send, in response to the registration request, a challenge string; and
determine that one or more domain name system (DNS) records of the domain have been updated with the challenge string.

8. The system of claim 6, wherein the one or more processors are further configured to:
receive a request to update the mapping to include one or more additional source identifiers, the request being associated with the user; and
determine that the request to update the mapping was received from a computing device corresponding to the user, and in response, update the mapping to include the one or more additional source identifiers.

9. The system of claim 8, wherein to determine that the request to update the mapping was received from a computing device corresponding to the user, the one or more processors are configured to determine whether the computing device corresponds to a user account for the user.

10. The system of claim 6,
wherein the domain is a first domain, and
wherein the one or more first source identifiers mapped to the user comprise an email address corresponding to a second domain different from the first domain.

11. The system of claim 1, wherein the second source identifier comprises at least one of:
a phone number,
an email address,
a user account of an online platform, or
an internal network identifier for a device in a network of plurality of devices.

12. The system of claim 1, wherein the digital certificate is an Extended Validation (EV) digital certificate.

13. The system of claim 1, wherein the digital certificate comprises one or more third source identifiers, and wherein the first source identifier is different from the one or more third source identifiers.

14. One or more computer-readable storage media storing instructions that when executed by one or more processors, causes the one or more processors to perform operations comprising:
receiving a verification request to verify the source of a communication between a source computing device and a recipient computing device, the verification request comprising a second source identifier;
determining, through accessing of a database, whether the database includes a first source identifier from among one or more user source identifiers stored in the database, the first source identifier matching the second source identifier; and
when the database includes the first source identifier:
identifying the user mapped to the first source identifier, wherein the first source identifier and the user are mapped using a digital certificate associated by the system with the user; and
sending a response to the verification request to the recipient computing device, the response identifying the source of the communication as the user.

15. The computer-readable storage media of claim 14,
wherein the first source identifier comprises a first name mapped to the user;
wherein the second source identifier comprises a second name; and
wherein determining whether the database comprises a first source identifier matching the second source identifier comprises determining whether the second name of the second source identifier matches the first name mapped to the user.

16. The computer-readable storage media of claim 15,
wherein the second source identifier comprises a phone number; and
wherein determining whether the database comprises a first source identifier matching the second source identifier comprises determining whether the one or more user source identifiers comprise a phone number matching the phone number of the second source identifier.

17. The computer-readable storage media of claim 16, wherein the operations further comprise maintaining, in memory, the database.

18. (canceled)

19. The computer-readable storage media of claim 17,
wherein the digital certificate is further associated with a domain of one or more computing devices, and
wherein the operations further comprise generating a mapping between the first source identifier and the user, comprising:
receiving a registration request to register the user, the registration request comprising the digital certificate and data identifying the domain; and
authenticating the user using the digital certificate and the domain.

20. The computer-readable storage media of claim 19, wherein the operations further comprise:
sending, in response to the registration request, a challenge string; and
determining that one or more domain name system (DNS) records of the domain have been updated with the challenge string.

21. The computer-readable storage media of claim 19, wherein the operations further comprise:
receiving a request to update the mapping to include one or more additional source identifiers, the request being associated with the user; and
determining that the request to update the mapping was received from a computing device corresponding to the user, and in response, updating the mapping to include the one or more additional source identifiers.

22. The computer-readable storage media of claim 21, wherein determining that the request to update the mapping was received from a computing device corresponding to the user comprises determining whether the computing device corresponds to a user account for the user.

23. The computer-readable storage media of claim 19,
wherein the domain is a first domain, and
wherein the one or more first source identifiers mapped to the user comprises an email address corresponding to a second domain different from the first domain.

24. The computer-readable storage media of claim 14, wherein the second source identifier comprises at least one of:
a phone number,
an email address,
a user account of an online platform, or
an internal network identifier for a device in a network of plurality of devices.

25-26. (canceled)

27. A system comprising:
one or more processors coupled to memory, the one or more processors configured to:
receive a registration request from a user to register the user, the registration request having first information including a digital certificate and a domain, and one or more source identifiers identifying sources of communication from the user to one or more computing devices;
send, in response to the registration request, a challenge string;
determine, by the one or more processors, whether one or more domain name system (DNS) records of the domain have been updated with the challenge string; and
when the one or more domain name system (DNS) records of the domain have been updated with the challenge string:
register the user as associated with the first information, and
map the one or more source identifiers to the user.

28. (canceled)

29. The system of claim 27, wherein the one or more processors are further configured to determine that the request to update the mapping was received from a computing device corresponding to the user, wherein to determine that the request to update was received from the computing device, the one or more processors are further configured to determine whether the computing device corresponds to a user account for the user.
